(19) United States
(12) Patent Application Publication
(10) Pub. No.: US 2008/0115566 A1
(43) Pub. Date: May 22, 2008

(54) Determination of the Seal Quality of Packages

(75) Inventor: Antonius Johannes Van Rootselaar, Bilthoven (NL)

Correspondence Address: YOUNG & THOMPSON, 209 Madison Street, Suite 500, ALEXANDRIA, VA, 22314, US

(73) Assignee: BLUEPRING HOLDING B.V., WOERDEN (NL)

(21) Appl. No.: 11/795,891

(22) PCT Filed: Jan. 24, 2006
(86) PCT No.: PCT/NL06/50015

§ 371 Date: Jul. 24, 2007

(30) Foreign Application Priority Data
Jan. 24, 2005 (NL) 1028103

(51) Int. Cl. G01M 3/26

(52) U.S. Cl. 73/49.3

(57) ABSTRACT

Method and device for determining the seal quality of packages, such as bags partially filled with products and protective gas. To this end these bags are directed between two opposing conveyors, the distance between these conveyors being less than the height of the packages, so that these are compressed. By taking measurements at one or two locations a verdict can be given on the seal quality of the packages. With this arrangement one of the conveyors is set up so that it can be moved relative to the other in order to ensure a more or less constant pressure on the packages. In order to achieve an accurate measurement it is proposed to measure the displacement resulting from this pressing on the packages at the conveyor that can be moved, using as reference the sub-frame of the conveyor that cannot be moved.

The present invention relates to a method for testing the seal quality of packages partially filled with products comprising passing said packages between first and second conveyor means located some distance apart, each in a first and second sub-frame, respectively, which sub-frames are connected via a main frame, wherein the first conveyor means are urged towards the second conveyor means for applying a load to said packages between them, wherein the mutual displacement of said transport means is measured at a first location using means for measuring displacement and on the basis of this the seal quality of said packages is determined.

Such a method is disclosed in U.S. Pat. No. 5,786,530. In this publication whether packages, such as bags partially filled with product, are sealed is determined by directing these packages over an underlying conveyor belt as second transport means and a construction consisting of an array of rollers located above it. This array of rollers is provided with a lead-in portion and a predetermined load is arranged on the array of rollers. The load is transferred to the bags and the resulting displacement of the array of rollers is measured. There is optionally a second array of rollers downstream of the first array of rollers, the bags being subjected to a load once more. The displacement is measured on account of the fact that the means for measuring displacement are mounted at the location where the load is transferred, the first sub-frame in the case of U.S. Pat. No. 5,786,530.

In WO 99/20991 use is made of two conveyor belts located opposite one another as transport means. The lower conveyor belt is tensioned and is displaced when the bags are passed though. The displacement of the lower conveyor belt is measured and is indicative of the seal quality of the bags. In this case the displacement is measured using mechanical, optical and ultrasonic sensors. These are set up to measure the movement relative to a fixed reference. This reference is the frame of the conveyor under tension.

A further device for testing the seal quality of packages is disclosed in GB 2 259 776, wherein the displacement of the first transport means takes place with a rotary arm. The angle of rotation of this arm relative to the main frame is measured.

U.S. Pat. No. 4,671,101 discloses a test device for determining the thickness of packages by optical means, where the optics used for this are mounted in an undefined manner.

EP 1 411 337 discloses a construction with first transport means that can pivot using tilt arms, the tilt angle of the tilt arms relative to the main frame being measured.

U.S. Pat. No. 6,202,476 also makes use of a measurement point that is referenced to the main frame.

U.S. Pat. No. 5,533,385 describes a load cell where the load is measured with respect to the main frame.

In the packaging industry it is a requirement that the sealing of packages can be tested at high speed. In the industry for packaging potato crisps, for example, bags of potato crisps are produced at relatively high speed and it is necessary to check these for seal quality immediately. After all, these bags are filled with product and a protective gas (such as air). The seal quality not only concerns the sealing of the side and end seams but also the integrity of the foil material that is used for the production of such bags.

It has been found that with the devices described above it is not possible to achieve an accurate measurement under all circumstances. In particular problems with setting up the device have been observed and it is particularly difficult to test packages of different formats.

The aim of the present invention is to avoid this disadvantage and to provide a method with which measurements can be made with little effort and at high speed that accurately indicate whether specific packages meet the requirements specified above.

This aim is realised with a method as described above in that said displacement is measured by directly measuring the displacement of said first conveyor means relative to said second sub-frame.

According to the invention the “fixed” part of the means for measuring displacement is not joined to the frame of the first conveyor means or the main frame, which are moved further or less far towards the second conveyor means, but is directly joined to (the sub-frame of) the second transport means. That is to say the change in the volume of the package is measured in a very accurate manner, no account being taken of displacements in the sub-frame of the first conveyor means and in the main frame that connects the first and second conveyor means to one another. By such direct measurement of the change in height relative to the second conveyor means even very small changes in volume that are reflected in a variation in the height of a package can be registered very accurately. Consequently it is possible not only to test for large leaks in packages such as those that are, for example, caused by sealing imperfections, but also for smaller defects in, for example, foil material. As an example of the small displacements mentioned above, values of 0.05 mm and smaller are mentioned.

According to a particular embodiment of the present invention a measurement is carried out in each of two locations some distance apart in the direction of transport of the objects. More particularly the pressure on the packages is maintained between said two locations. That is to say the packages are continually kept under pressure during a determined transport path and by comparison of the displacement at a first location and the displacement at a second location a verdict on the seal quality of a package can be given.

Preferably the conveyor means comprise two conveyor belts located opposite one another. These conveyor belts have to be provided with gas discharge means to prevent the foil material forming a perfect seal against the conveyor belt material or the like despite there being an opening therein. The conveyor means have to be designed such that the bags are as far as possible not deformed during transport. This applies in particular to the embodiment described above where measurements are taken at two locations, wherein the conditions between the two locations have to remain unchanged as far as possible.

According to a further advantageous embodiment having a measurement path, before being subjected to a measurement the packages are first brought into a stable state by subjecting them to a pre-pressure. This pre-pressure may be the same as the measuring pressure, but may equally well differ from this. There can be a similar construction at the second measuring location. In this way the effect of feeding and discharging of the packages can be eliminated as far as possible. Obviously there can be sorting means downstream of the measuring locations to achieve the separation between accepted and rejected packages.

The invention also relates to an device for testing the seal quality of partially filled packages comprising a first conveyor fitted in a first sub-frame and an opposing second conveyor fitted in a second sub-frame, which sub-frames are accommodated in a main frame, wherein said first conveyor can be moved in the direction of said second conveyor relative to the frame and said second conveyor and there are means for measuring displacement for measuring the displacement of said first conveyor, said means for measuring displacement comprising a stationary part and a movable part to be joined to said first conveyor, wherein the stationary part of said means for measuring displacement is directly joined to said second sub-frame. More particularly the present invention relates to an device wherein said first conveyor can be moved towards said second conveyor at a first location and a second location some distance therefrom, wherein said movement at said first location is independent of said movement at said second location and wherein there are means for measuring displacement at both locations. It will be understood that further constructions for detecting the presence of a package will be associated with the device and more particularly with the measurement. With the above construction the positioning of the second conveyor is, in principle, not important. That is to say, in contrast to the state of the art, it is no longer necessary for the first and second conveyor to run exactly parallel with respect to one another. Consequently it is moreover possible to make the first sub-frame and the main frame lighter because these do not have to be constructed such that even small displacements caused by the pressure applied by the first conveyor do not lead to a non-measurable displacement as a result of the inherent elasticity of the first sub-frame and the main frame.

The means for measuring displacement are preferably made as a linear sensor, that is to say a linear displacement is measured. Obviously it is possible to convert such a linear displacement into a rotation, the revolutions being a measure for the linear displacement.

According to a further advantageous embodiment of the present invention two means for measuring displacement are provided, one upstream and one downstream relative to one another. With this arrangement the capacity of the device according to the present invention can be further increased.

To enable accurate positioning of the packages, such as bags, between the first and second transport means, one of the transport means is provided with a lead-in portion. This can comprise a conveyor extending at an angle to the direction of movement, as a result of which the package moves into the space between the two transport means in a funnel-shaped manner. In addition, at the location of the first pressure point and when a conveyor belt is used, there can be a tilting mechanism, such as a tiltable pressure shoe. As a result the accuracy of measurement can be still further enhanced without there being any risk of packages rolling up.

The invention will be explained in more detail below with reference to a drawing. In the drawing:

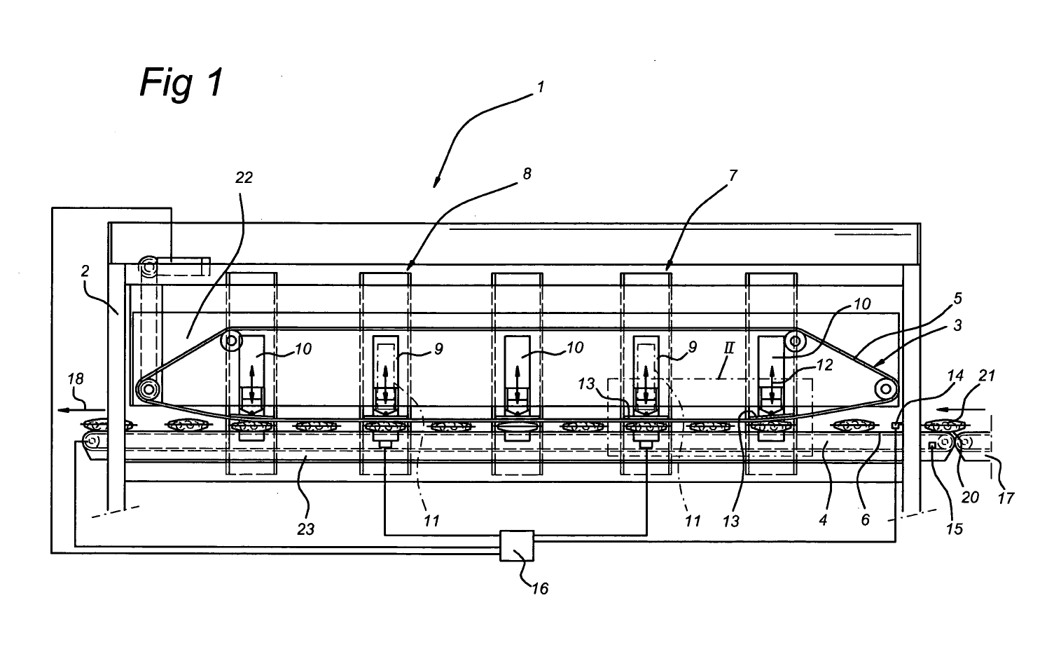

FIG. 1 shows, diagrammatically, a side view of the device according to the invention;

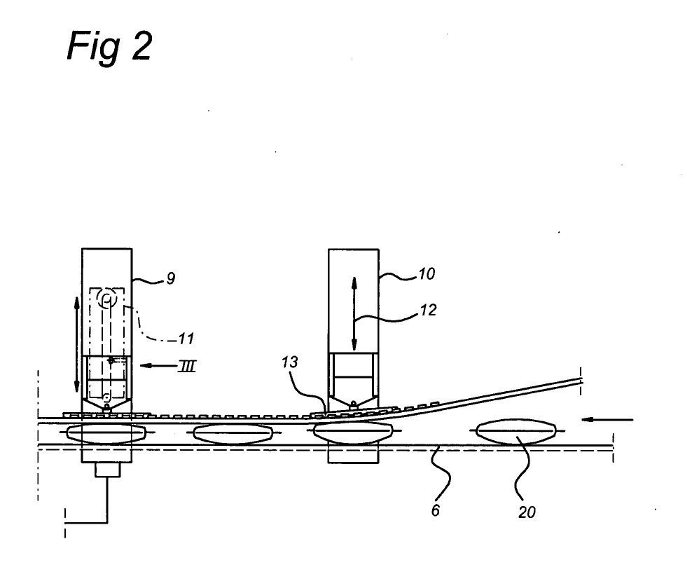

FIG. 2 shows a detail of the lead-in portion of the device according to FIG. 1, and

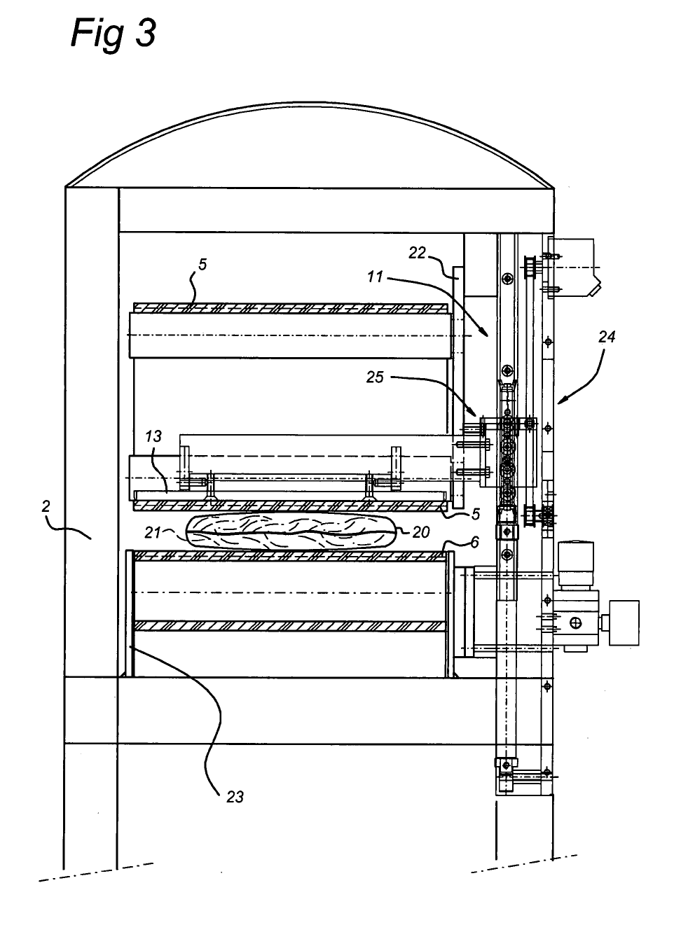

FIG. 3 shows, diagrammatically, the means for measuring displacement.

In FIG. 1 the device according to the present invention is indicated in its entirety by 1. This consists of a main frame 2. A first conveyor 3 with sub-frame 22 is fitted in frame 2 and a second conveyor 4 with sub-frame 23. The first conveyor is a conveyor belt and the belt thereof is indicated by 5. The lower part (in the drawing) of the first conveyor can be moved upwards and downwards. This movement is achieved by pressure means 9 and 10, which can be moved in the direction of arrow 12. The force applied is produced by a fluid not shown in more detail, such as a weight, hydraulic fluid or compressed air. The pressure at each of the pressure means 9, 10 can continually be different. A force is applied on the lower part of the conveyor belt via the pressure means 9, 10 with pressure shoes 13.

The second conveyor 4 is fitted entirely immovably (vertically) in sub-frame 23. This is also made as a conveyor belt and the belt is indicated by 6. Both conveyor belts 5 and 6 are made such that gas emanating from the bags can escape easily. To this end there can be a ripple structure. The conveyor belts of the first and second conveyors move at the same speed so as to prevent deformation of the packages. There are displacement meters 11 at the location of the pressure means 9. As can be seen in FIG. 3, each displacement meter 11 consists of a “fixed part” 24 and a part 25 that can be moved relative thereto. The movable part in the present embodiment is made as a belt/pulse counter moving up and down. The “fixed part” 24 is directly joined to the sub-frame 23 of the second conveyor 4. This is in contrast to the constructions according to the prior art, where the “fixed part” is joined to the sub-frame 22 of the upper conveyor 3. There is a detector 14 which detects the presence of a package 20 filled with products 21, such as potato crisps. This package has to be gas tight and the gas tightness of the package is checked with the device. It can be seen from FIG. 2 that the belt 5 is provided with teeth 15.

There is a controller 16 that, apart from being connected to the displacement meters 11 and the detector 14, is also connected to the drive motors of at least the belt 5 and preferably belt 6. This connection can moreover include an optical link to the teeth 15. In this way, once the position of a package 20 has been detected, it is possible to determine accurately the progress of the packages 20 between the two belts 5 and 6.

The device described above functions as follows:

A package 20 coming from a feed conveyor 17 moves past detector 14. Further movement then takes place as a result of movement of both belts 5 and 6 at essentially the same speed in the direction of arrow 18 (lower part of belt 5, upper part of belt 6), so that the packages reach the pressure means 9 furthest on the right. However, before this point in time, in supplementary pressure means 10, the package is placed in a stable position and the contents thereof are also arranged optimally for testing. When the pressure means 9 furthest to the right are reached, as a result of the pressing force prevailing at this location, which is caused by the package 20, the compression of the lower part of belt 5 resulting from this is determined by displacement meter 11. In this case the displacement meter 11 uses the sub-frame 23 of the second conveyor belt as reference. The package 20 is then maintained continually under pressure, which pressure is also maintained by the supplementary pressure means 10 in the middle.

Subsequently, at the pressure means 9 on the left, such a measurement is again carried out by the left-hand displacement meter 11. The displacements measured by both displacement meters 11 are compared and on the basis of this it is determined whether a package is acceptable. If this is the case, transport is continued, but if this is not the case a package is removed in some way or other.

Because the displacement meters 11 are located away from the pressure means 9, 10, displacements of the first sub-frame and main frame that are not relevant for the measurement and have an adverse effect on this will be filtered out. This may, for example, include flattening of a package in some way or other, which is not relevant for the measurement. With the present invention the pressure in the package is measured accurately at two locations. After all, this pressure is responsible for displacement of the lower part of the upper belt 5.

Although the invention has been described above with reference to a preferred embodiment, it must be understood that variants are possible. On the one hand, it is possible to extend the construction described above. For instance, it is possible for there to be lateral guides for the packages, as a result of which the packages are positioned accurately between the two conveyor belts. It must be understood that the mechanism described above can also be used “the other way round”, that is to say a construction is conceivable wherein the upper part of lower conveyor 4 is urged upwards, while the resulting displacement of the lower part of upper conveyor 5 is measured with reference to the sub-frame of the upper conveyor. That is to say the position of the first and second conveyor in a space is not important for the present invention. However, it is also possible under certain circumstances to measure the compression of the transport means concerned opposite the other transport means at only one location, the other transport means being compelled towards the first mentioned transport means with a certain force or pressure. Moreover, it is possible to use any other transport means instead of a belt. These and other variants are obvious to a person skilled in the art after reading the above description and fall within the scope of the appended claims.

1-13. (canceled)

14. Method for testing the seal quality of packages partially filled with products comprising passing said packages between first and second conveyor means located some distance apart, fitted in a first and second sub-frame respectively, said sub-frames being connected via a main frame, wherein the first conveyor means are urged towards the second conveyor means for applying a load to said packages between them, wherein the mutual displacement of said conveyor means is measured at a first location and on the basis of this the seal quality of said packages is determined, said displacement being measured by directly measuring the displacement of said first conveyor means relative to said second sub-frame.

15. Method according to claim 14, wherein said measurement of said displacement relative to said second conveyor means relates to the displacement relative to the second sub-frame.

16. Method according to claim 14, wherein the mutual displacement of said transport means is measured at a second location downstream of said first location, the load on the packages at said first and said second location being applied using the same conveyor means and said packages continually being loaded in the path from first location to second location.

17. Method according to claim 14, wherein upstream of said first location solely compelling of said conveyor means towards one another takes place.

18. Method according to claim 14, wherein said conveyor means comprise two opposing continuous transport surfaces.

19. Method according to one claim 14, wherein said first conveyor means are urged towards the second transport means by fluid pressure.

20. Device for testing the seal quality of partially filled packages comprising a first conveyor fitted in a first sub-frame and an opposing second conveyor fitted in a second sub-frame, said sub-frames being accommodated in a main frame, wherein said first conveyor can be moved in the direction of said second conveyor relative to the frame and said second conveyor and there are means for measuring displacement for measuring the displacement of said first conveyor, said means for measuring displacement comprising a stationary part and a movable part to be joined to said first conveyor, characterised in that the stationary part of said means for measuring displacement is directly joined to said second sub-frame.

21. Device according to claim 20, wherein said join between said means for measuring displacement and the second conveyor comprise a join with said second sub-frame.

22. Device according to claim 29, wherein said first conveyor can be moved towards said second conveyor at a first location and a second location some distance therefrom, wherein said movement at said first location is independent of said movement at said second location and wherein there are means for measuring displacement at both locations.

23. Device according to claim 20, wherein said first conveyor comprises a conveyor belt.

24. Device according to claim 23, wherein said pressure means are fitted at the location of the means for measuring displacement.

25. Device according to claim 20, wherein there are auxiliary pressure means upstream/downstream of said pressure means.

26. Device according to claim 20, wherein said conveyor is provided with gas discharge means.
